(19) United States
(12) Patent Application Publication
(10) Pub. No.: US 2009/0241130 A1
(43) Pub. Date: Sep. 24, 2009

(54) Virtual Interfacing Device and Related Method for Controlling the Same

(76) Inventor: Chih-An Su, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/275,210

(22) Filed: Nov. 20, 2008

(30) Foreign Application Priority Data
Mar. 18, 2008 (TW) 097109465

(51) Int. Cl. G06F 3/00

(52) U.S. Cl. 719/324

(57) ABSTRACT

To reduce product development cost, a virtual interfacing device for virtualization of a hardware device of an electronic product operating in an operating system providing a driving unit corresponding to the hardware device is provided. The virtual interfacing device relays communication between the hardware device and a Java application and includes a virtual unit and an event unit. The virtual unit includes virtual data corresponding to the hardware device, and modifies the virtual data or provides the virtual data for the Java application according to access information generated by the Java application. The event unit generates Java event information for the driving unit according to the virtual data or modifies the virtual data according to device event information generated by the driving unit.

### BACKGROUND OF THE INVENTION

1. Field of the Invention

The present invention relates to a virtual interfacing device and related method, and more particularly to a virtual interfacing device and related method capable of communicating with Java applications.

2. Description of the Prior Art

Java is one of the most widely used programming languages nowadays, having a dominant advantage of “Write Once, Run Anywhere”. That is, a Java binary code is operable in Unix, Linux, Macintosh and Windows operating systems (OSs), needless of further program modification. With flexible OS compatibility, a trade-off is that the Java code cannot directly access drivers of an electronic device in any of the OSs, and can only achieve this with a Java Virtual Machine (JVM).

During researching and development of medical and consumer electronic products, a developer needs to establish an OS, install drivers of embedded electronic devices, and then introduce the JVM and needed Java applications for hardware and software functions. Some functions are difficult to be carried out by indirect means that communicates through the JVM between the Java application and the drivers of the OS. In this situation, Java Native Interface (JNI) is provided as a solution.

JNI utilizes a function library of the C/C++ programming language to solve the problem of few direct conversations between the Java application and the OS. The Java application is allowed to use the C/C++ library and instructions to control the electronic devices and kernel programs of the OS. However, the JNI eliminates the dominant advantages of Java. Combining the Java program with the C/C++ program through the JNI causes more programming complexity and degrades an ability of object oriented modeling and design. In addition, although JNI provides tight association between the Java application and the OS, the Java application loses the cross-platform ability.

By means of JNI, the product developer has to import needed C/C++ library and instructions according to internal devices of the electronic product. Therefore, the product developer needs to be familiar with Java applications and JNI and modify the Java applications, thereby increasing development cost and eliminating the cross-platform ability of the Java applications.

### SUMMARY OF THE INVENTION

The present invention therefore provides a virtual interfacing device and related method for virtualization of a hardware device to achieve communication between a Java application and the hardware device.

An embodiment of the invention discloses a virtual interfacing device of a hardware device for virtualizing the hardware device to relay communication between the hardware device and a Java application. The hardware device operates with an operating system including a driving unit corresponding to the hardware device. The virtual interfacing device includes a virtualization unit and an event unit. The virtualization unit includes virtual data corresponding to the hardware device and is configured for modifying the virtual data or providing the virtual data for the Java application according to access information generated by the Java application. The event unit is used for generating Java event information for the driving unit according to the virtual data, and reading and writing the virtual data according to device event information generated by the driving unit.

An embodiment of the invention further discloses a virtualization method of virtualizing a hardware device to relay communication between the hardware device and a Java application. The hardware device operates with an operating system including a driving unit corresponding to the hardware device. The virtualization method includes providing virtual data corresponding to the hardware device and an event layer, modifying the virtual data or providing the virtual data for the Java application according to access information generated by the Java application, utilizing the event layer to generate Java event information for the driving unit according to the virtual data, and then utilizing the event layer to read and write the virtual data according to device event information generated by the driving unit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an electronic product according to an embodiment of the invention.

FIG. 2 is a schematic diagram of a virtualization process according to an embodiment of the invention.

FIG. 3 is a schematic diagram of a virtualization process according to another embodiment of the invention.

### DETAILED DESCRIPTION

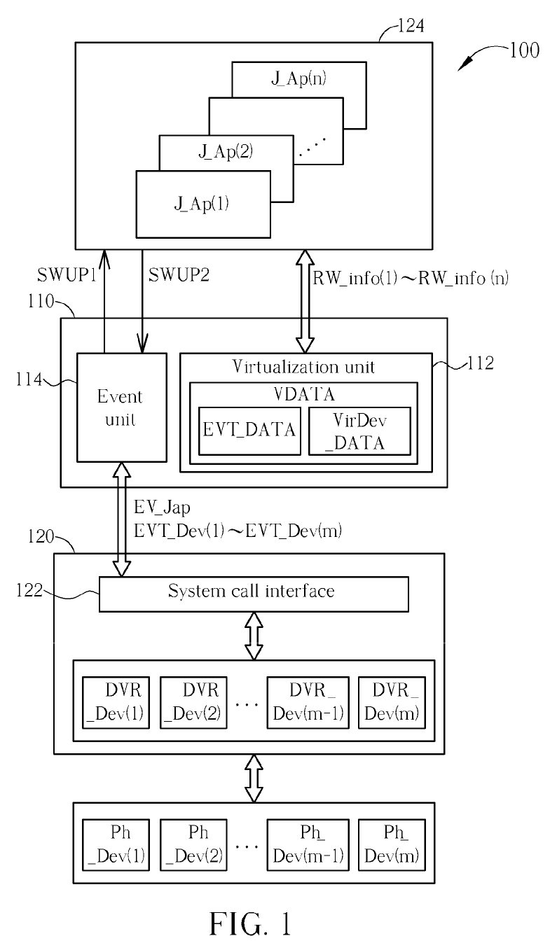

Please refer to FIG. 1, which is a schematic diagram of an electronic product 100 according to an embodiment of the invention. The electronic product 100 can operate in a Linux, Windows, or other operating system and includes Java applications J_Ap(1)-J_Ap(n), a virtual interfacing unit 110, a kernel module 120 and hardware devices Ph_Dev(1)-Ph_Dev(m). The Java applications J_Ap(1)-J_Ap(n) operating in a JVM (Java Virtual Machine) 124 generate access information RW_info(1)-RW_info (n) according to embedded Java functions to exchange information with the virtual interfacing unit 110. The kernel module 120 includes a system call interface 122 and driving units DVR_Dev(1)-DVR_Dev (m) that drive the hardware devices Ph_Dev(1)-Ph_Dev(m) and generate device event information EVT_Dev(1)-EVT_Dev(m) according to operations of the hardware devices Ph_Dev(1)-Ph_Dev(m), respectively.

The virtual interfacing unit 110 virtualizes the hardware devices Ph_Dev(1)-Ph_Dev(m) and includes a virtualization unit 112 and an event unit 114. The virtualization unit 112 includes virtual data VDATA corresponding to the hardware devices Ph_Dev(1)-Ph_Dev(m) and is configured for modifying the virtual data VDATA or providing the virtual data VDATA for the corresponding Java application according to any of the access information RW_info(1)-RW_info (n). The event unit 114 generates Java event information EV_Jap according to the virtual data VDATA and outputs the Java event information EV_Jap to the corresponding driving unit through the system call interface 122. Furthermore, the event unit 114 reads and writes the virtual data VDATA according to any of the device event information EVT_Dev(1)-EVT_Dev(m).

In addition, the event unit 114 outputs a first awaking signal SWUP1 for controlling the involved Java application to generate the access information or receives a second awaking signal SWUP2 outputted by the involved Java application for reading and writing the virtual data VDATA and generating the Java event information EV_Jap according to the virtual data VDATA.

The virtual data VDATA includes virtual device data VirDev_DATA for storing hardware and software information of the hardware device Ph_Dev(1)-Ph_Dev(m), and event device data EVT_DATA for providing the event unit 114 or the Java applications J_Ap(1)-J_Ap(n) with the associated hardware information of the hardware device when the event unit 114 or the Java application J_Ap(1)-J_Ap(n) modifies the virtual device data VirDev_DATA. An exemplary embodiment of the virtual data VDATA is described with Extensible Markup Language (XML) as follows.

1. The virtual device data VirDev_DATA:

File Context(XML)(Device Info)
W3C XML
<device_Info>
<device_name>
<device_type>
<device_site>
<device_ioctl_cmd>
<device_ioctl_cmd_num>
<devuce_ioctl_cmd>
<device_status>
<device_cmding>
<device_cmding_ioctl>
<ioctl_cmd>
<ioctl_cmd_parameter>
<device_cmding_read>
<device_cmding_open>
<device_cmding_close>
<device_cmding_write>
<write_type>
<write_context>
<device_response>
<device_request>
<device_cmd_type>
<device_cmd_cmd>
<device_cmd_parameter>
<device_cmd_response>
<device_return_value>
<device_return_parameter>
<device_return_context>

The abovementioned program of the virtual device data VirDev_DATA includes a device information block <device_Info>, a command information block <device_cmding> and a response information block <device_response>. The device information block <device_Info> stores identity information <device_name>, control information <device_ioctl_cmd>, an address <device_site>, a type <device_type>, and a status <device_status> of any of the involved hardware devices Ph_Dev(1)-Ph_Dev(m). Each time the event unit 114 finishes reading the device information block <device_Info>, content of the device information block <device_Info> is cleared. The command information block <device_cmding> stores commands generated by the Java application attempting to control any of the hardware devices Ph_Dev(1)-Ph_Dev(m), and the commands include a reading command <device_cmding_read>, a writing command <device_cmding_write>, an opening command <device_cmding_open>, and so on. The response information block <device_response> stores values or parameters returned by the event unit 114. The involved Java application clears content of the response information block <device_response> after reading is finished.

2. The event device data EVT_DATA:

File Context(XML)
W3C XML
<device_Java>
<device_name>
<device_real_name>
<device_type>
<device_status>
<device_Event>
<device_name>
<device_real_name>
<device_type>
<device_status>

The abovementioned program of the event device data EVT_DATA includes a Java block <device_java> and an event block <device_Event>. When the event unit 114 uses the first awaking information SWUP1 to notify one of the Java applications J_Ap(1)-J_Ap(n), the Java block <device_java> provides the involved Java application with identity information, a type, and a status of the destined hardware device, and the Java application clears the content of the Java block <device_java> after receiving the information. Similarly, when one of the Java applications J_Ap(1)-J_Ap(n) uses the second awaking information SWUP2 to notify the event unit 114, the event block <device_Event> provides the event unit 114 with the identity information, the type, and the status of the destined hardware device, and the event unit 114 clears the content of the event block <device_Event> after receiving the information. In addition, the event device data EVT_DATA is preferably a part of the virtual device data VirDev_DATA, occupying less memory space, so that data transmission payload can be reduced during notification.

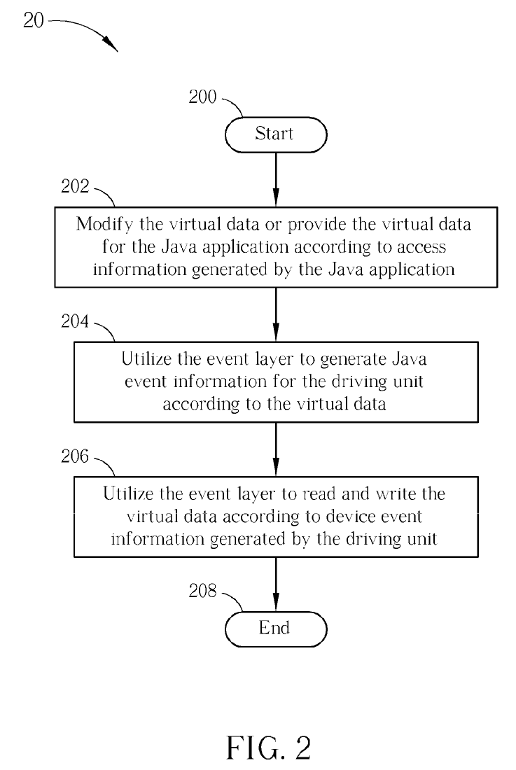

Please refer to FIG. 2, which is a schematic diagram of a virtualization process 20 according to an embodiment of the invention. The virtualization process 20 is utilized for virtualizing an electronic device operating with an operating system and thereby provides virtual data corresponding to the electronic device and an event layer to relay communication between the electronic device and a Java application. The virtualization process 20 is preferably realized in the electronic device 100 and includes the following steps:

Step 200: Start.

Step 202: Modify the virtual data or provide the virtual data for the Java application according to access information generated by the Java application.

Step 204: Utilize the event layer to generate Java event information for the driving unit according to the virtual data.

Step 206: Utilize the event layer to read and write the virtual data according to device event information generated by the driving unit.

Step 208: End.

According to the virtualization process 20, the event layer correspondingly generates the Java event information, including operations indicated by the Java application, according to the virtual data, when the Java application modifies the virtual data according to the access information. As a result, the event layer can control the destined hardware device through the driving unit. Preferably, the event layer is triggered to generate the Java event information by second awaking information outputted from the Java application. When the hardware device activates a specific operation spontaneously or in response to the operations indicated by the Java application, the driving unit generates and outputs the device event information to the event layer, and accordingly the event layer modifies the Java event information. In addition, the event layer outputs first awaking information to trigger the Java application to generate the access information, so as to obtain the virtual data.

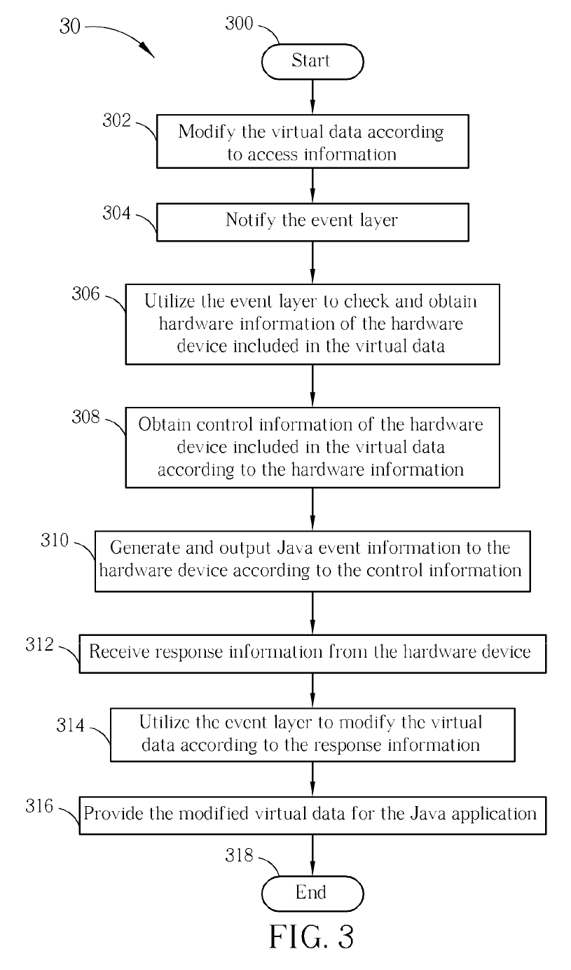

For further concrete understanding of the invention concept, please refer to FIG. 3, which is a schematic diagram of a virtualization process 30 according to an embodiment of the invention. The virtualization process 30 provides virtual data corresponding to a hardware device and an event layer to virtualize the hardware device operating with an operating system and thereby relay communication between the hardware device and a Java application. The virtualization process 30 is mainly used in a situation where a Java application attempts to control the hardware device, and includes the following steps:

Step 300: Start.

Step 302: Modify the virtual data according to access information.

Step 304: Notify the event layer.

Step 306: Utilize the event layer to check and obtain hardware information of the hardware device included in the virtual data.

Step 308: Obtain control information of the hardware device included in the virtual data according to the hardware information.

Step 310: Generate and output Java event information to the hardware device according to the control information.

Step 312: Receive response information from the hardware device.

Step 314: Utilize the event layer to modify the virtual data according to the response information.

Step 316: Provide the modified virtual data for the Java application.

Step 318: End.

Preferably, the virtualization process 30 is carried out in the virtual interfacing device 110. In this situation, the virtual data and the event layer is seen as the virtual unit 112 of the virtual data VDATA and the event unit 114 in the virtual interfacing device 110, respectively.

Take a scenario where the Java application J_Ap(1) attempts to control the hardware device Ph_Dev(m) for example. The Java application J_Ap(1) first generates the access information RW_info(1). According to the virtualization process 30, the virtual unit 112 writes the device identity, the device type, the control and the device status of the hardware device Ph_Dev(m) into both the virtual device data VirDev_DATA and the event block <device_Event> of the event device data EVT_DATA<device_Event> in accordance with the access information RW_info(1). The Java application J_Ap(1) generates the second awaking information SWUP2 to awake the event unit 114 to read the event block <device_Event>. Finally, the event unit 114 obtains the identity and status information of the hardware device Ph_Dev(m), and thereby generates the Java event information EV_Jap. The driving unit DVR_Dev(m) notifies the hardware device Ph_Dev(m) of corresponding operations after receiving the Java event information EV_Jap through the system call interface 122.

According to the operating state of the hardware device Ph_Dev(m), the driving unit DVR_Dev(m) returns the device event information EVT_Dev(m) to the event unit 114. Then, the event unit 114 modifies the virtual device data VirDev_DATA and the Java block <device_java> of the event device data EVT_DATA. Finally, the event unit 114 outputs the first awaking information SWUP1 to notify the Java application J_Ap(1), and thereby the Java application J_Ap(1) obtains corresponding control information from the virtual device data VirDev_DATA.

When the hardware device spontaneously changes its operation, the event unit 114 can perform a process to transfer control information to the destined Java application. The process is similar to the virtualization process 30 and detailed description thereof is omitted herein.

In conclusion, the embodiments of the invention provide a virtual interface between the hardware device and the Java application, including the following advantages: 1. It is not necessary to combine the Java application with C/C++ functions, thereby maintaining program integrity and unity; 2. The Java application and the virtual interface can be implanted with individual modules; 3. A product developer does not have to modify the Java application according to the hardware devices in the electronic product, thereby maintaining the cross-platform ability of the Java application.

Those skilled in the art will readily observe that numerous modifications and alterations of the device and method may be made while retaining the teachings of the invention.

What is claimed is:

1. A virtual interfacing device of a hardware device for virtualizing the hardware device to relay communication between the hardware device and a Java application, the hardware device operating with an operating system comprising a driving unit corresponding to the hardware device, the virtual interfacing device comprising:
a virtualization unit comprising virtual data corresponding to the hardware device, the virtualization unit configured for modifying the virtual data or providing the virtual data for the Java application according to access information generated by the Java application; and
an event unit for generating Java event information for the driving unit according to the virtual data, and reading and writing the virtual data according to device event information generated by the driving unit.

2. The virtual interfacing device of claim 1, wherein the event unit outputs a first awaking signal for controlling the Java application to generate the access information.

3. The virtual interfacing device of claim 2, wherein the event unit receives a second awaking signal outputted by the Java application for reading and writing the virtual data and generating the Java event information for the driving unit according to the virtual data.

4. The virtual interfacing device of claim 1, wherein the virtual data comprises virtual device data for storing hardware information and software information of the hardware device and an event device data for providing the event unit or the Java application with the hardware information of the hardware device when the virtual device data is modified.

5. The virtual interfacing device of claim 4, wherein the virtual device data comprises:
a device information block for storing identity information, control information, an address, a type, and a status of the hardware device;
a command information block for storing commands generated by the Java application; and
a response information block for storing values or parameters returned by the event unit.

6. The virtual interfacing device of claim 5, wherein the event device data comprises parts of the virtual device data.

7. The virtual interfacing device of claim 4, wherein the event device data comprises:
a Java block for providing the Java application with the identity information, the type, and the status of the hardware device; and
an event block for providing the event unit with the identity information, the type, and the status of the hardware device.

8. The virtual interfacing device of claim 1, wherein the operating system is a Linux operating system or a Windows operating system.

9. The virtual interfacing device of claim 1, wherein the Java application operates within a Java virtual machine.

10. A virtualization method of virtualizing a hardware device to relay communication between the hardware device and a Java application, the hardware device operating with an operating system comprising a driving unit corresponding to the hardware device, the virtualization method comprising:
providing virtual data corresponding to the hardware device and an event layer;
modifying the virtual data or providing the virtual data for the Java application according to access information generated by the Java application;
utilizing the event layer to generate Java event information for the driving unit according to the virtual data; and
utilizing the event layer to read and write the virtual data according to device event information generated by the driving unit.

11. The virtualization method of claim 10 further comprising utilizing the event layer to output a first awaking signal for controlling the Java application to generate the access information.

12. The virtualization method of claim 11 further comprising utilizing the event layer to receive a second awaking signal outputted by the Java application for reading and writing the virtual data and generating the Java event information for the driving unit according to the virtual data.

13. The virtualization method of claim 10, wherein the virtual data comprises virtual device data for storing hardware information and software information of the hardware device and an event device data for providing the event layer or the Java application with the hardware information of the hardware device when the virtual device data is modified.

14. The virtualization method of claim 13, wherein the virtual device data comprises:
a device information block for storing identity information, control information, an address, a type, and a status of the hardware device;
a command information block for storing commands generated by the Java application; and
a response information block for storing values or parameters returned by the event layer.

15. The virtualization method of claim 14, wherein the event device data comprises parts of the virtual device data.

16. The virtualization method of claim 13, wherein the event device data comprises:
a Java block for providing the Java application with the identity information, the type, and the status of the hardware device; and
an event block for providing the event layer with the identity information, the type, and the status of the hardware device.

17. The virtualization method of claim 10, wherein the operating system is a Linux operating system or a Windows operating system.

18. The virtualization method of claim 10, wherein the Java application operates within a Java virtual machine.
